(19) United States
(12) Patent Application Publication
(10) Pub. No.: US 2007/0220330 A1
(43) Pub. Date: Sep. 20, 2007

(54) Computer-Supported Diagnostic System, Based on Heuristics and System Topologies

(75) Inventors: Harald Nauerz, Karlsruhe (DE); Wojciech Oberdorfer, Blaubeuren (DE); Andre Schulz, Sindelfingen (DE)

Correspondence Address: FITCH, EVEN, TABIN & FLANNERY, P. O. BOX 18415, WASHINGTON, DC, 20036, US

(73) Assignee: DaimlerChrysler AG, Stuttgart (DE)

(21) Appl. No.: 11/587,166

(22) PCT Filed: Apr. 15, 2005
(86) PCT No.: PCT/EP05/04024

§ 371 Date: May 15, 2007

(30) Foreign Application Priority Data
Apr. 21, 2004 (DE) 10 2004 019 151.4

(51) Int. Cl. G05B 23/02

(52) U.S. Cl. 714/26

(57) ABSTRACT

The invention relates to a computer-supported diagnostic system in which the physical structure of the technical system to be diagnosed is implemented in the form of a structural model. If a fault code occurs in a component of the technical system which is capable of self-diagnostics, and thus also in the structural model, the fault location is searched for with a parameterizable path search by means of the path search algorithm as a function of the fault which has occurred in the structural model. The parameterization of the path search succeeds here by virtue of fault-specific heuristics. A heuristic in the sense of the invention is here a software module which can be selected as a function of a fault which has occurred, which module contains a fault-specific evaluation algorithm, which contains information about the set of candidates which are to be included in the troubleshooting, and which contains rule lists with fault record conditions which are used for a fault decision by the evaluation algorithm. The fault location is found if a state variable of a component in the structural model meets a fault record condition.

The invention relates to a diagnostic device, a computer-supported diagnostic system and a computer-supported method for carrying out diagnostics for a complex technical system such as, for example, a motor vehicle. The diagnostic system is based here on the system topology of the system to be examined and makes use of logical and physical relationships in the system topology in order to arrive at a diagnosis with an algorithm which is implemented by means of software.

Technological Principles:

The objective of acquiring diagnostic knowledge is to simplify troubleshooting. In the event of a breakdown it is desirable to have the most detailed information possible about possible causes of a fault. Causes of a fault can be control devices as well as components from the connected peripherals (plugs, lines, actuators, sensors etc.). However, computer-supported system diagnostics are not capable of detecting possible faults in a vehicle themselves. This requires information about detected faults from the control devices and this information has to be transmitted to the system diagnostics. Faults which are not detected by the control devices cannot be processed or diagnosed by the system diagnostics.

From the above explanation it follows that the inputs below are necessary to acquire diagnostic knowledge:
Information about the topology (control devices including peripherals). This means that information relating to the type of each component and to its connection to other components is necessary. This information is presented, for example, in circuit diagrams or is present in line set report files (also referred to as network lists). The type of a component can generally be identified by reference to the component name; various types of component have different name prefixes (for example “X23/5” is a junction, “N93” is a control device, “S117” is a switch etc.
Information about the faults which can be detected by the control devices. The diagnostic schedule of specifications of each control device contains a fault code table. This table provides information about all the faults which can be detected: when they occur (fault record condition), when they no longer occur (fault recovery condition), and what type of fault they are (software fault, under voltage/over voltage, line break, short circuit etc.).

In order to be able to acquire diagnostic knowledge from the abovementioned inputs, they must be combined with one another. That is to say the faults which can be detected by the control devices have to be assigned to their associated peripheral component; to do this it is sufficient to correctly assign the fault to the control device pin. Only then is it possible to arrive at conclusions about a component with respect to a given fault. The assignment between the fault code and control device pin has to be made by the system diagnosis author and be implemented in a software algorithm by programming means.

Known computer-supported diagnostic systems are known by the term model-based system diagnostics in the specialist field. Such diagnostic systems are described, for example, in DE 195 23 483 A1 and in DE 100 51 781 A1.

The objective of the model-based method is to acquire diagnostic knowledge from the use of a representation of the respective system which is as real as possible. The diagnostic knowledge acquired as a result is therefore most suitable for diagnosing the real system.

In order to be able to produce a representation of the system which is as real as possible, detailed modeling is necessary. This includes both the system topology (also referred to as structural model) and the system behavior (also referred to as behavior model); together these two items are referred to as “model” for the sake of simplicity (hence the name “model-based diagnostics”).

The structural model can be acquired from the circuit diagram or from the line set report files. The structural model can be produced automatically here, all that is necessary is to take account of possible variants.

The structural model in itself does not constitute a suitable representation of the real system. It has to be enhanced with behavior information—generally composed of mathematical relationships. This work can be automated only to a limited degree: for simple, standard components the behavior can be acquired from a library, but for complex components the system diagnosis author must input the behavior himself.

If the system model, composed of structural model and behavior model, is complete, it is possible to draw conclusions with respect to the behavior in various situations. In order to extract diagnostic behavior from this model, all the possible fault representations are then included in the model and the behavior is observed; this occurs within the scope of a series of simulations from which a database is produced. This database then contains the parameters of all the system components for all the fault combinations, that is to say as it were the behavior in any fault situation.

With a decision algorithm which is implemented in the diagnostic system, behavior representations which match a fault symptom are found in the database and in this way it is possible to arrive at the possible causes of a fault in a computer-supported fashion. However, in practice this method can often only be carried out for simple systems since the database for relatively complex systems may be very large. For this reason, in the past the approach of data reduction has been adopted, for example in DE 197 42 450 A1. The limitation to observable variables and theoretical considerations using graphs permit all the system nodes which do not influence the observable variables to be eliminated by means of a reduction graph.

A number of control devices implement very simple functions such as, for example, the operation of the roof or of the front seat passenger's door. The physical embodiment of such systems reflects the complexity of the function, i.e. such control devices have a small periphery and detect only a small number of faults. This does not require complex modeling and simulation and the system diagnosis author is able to produce the diagnostic knowledge himself manually using the available information. All that is required for this is an electronic data processing editor with which the functional relationships are recorded in the form of computer-supported decision rules, for example by simple “if . . . then . . . rules”.

Producing diagnostic knowledge manually has the following advantages:
The diagnostic knowledge can be formulated directly; no preparatory work is necessary here.

Producing diagnostic knowledge manually has the following disadvantages:
Different quality of the diagnostic knowledge. Since the production process is carried out manually, the quality of the diagnostic knowledge is dependent on the system diagnosis author. In order to guarantee a minimum level of quality, regular reviews are therefore necessary.
Poor transparency. The method of producing the diagnostic knowledge cannot be represented explicitly, it is performed by the system diagnosis author. Sufficient documentation makes this method transparent; this documentation has to be produced by the system diagnosis author.
Variants involve a large amount of expenditure. If a system has different variants, the production process has to be restarted for each variant. In certain cases certain parts can be reused.
Large amount of expenditure on maintenance. When amendments are made, in the worst case, i.e. if insufficient documentation is available, it is necessary to restart the production process.

The model-based method for acquiring diagnostic knowledge has, in contrast, the following advantages:
Guaranteed quality level. By using a suitable component library and modeling the behavior at the mathematical level it is possible to ensure a high degree of quality.
Good transparency. The system model represents a suitable piece of documentation for modeling.

The model-based method for acquiring diagnostic knowledge has the following disadvantages:
Complex process. The modeling work is complex even using a model-based tool. The modeling of the behavior is for the most part manual work, the simulation is time-consuming.
Variants involve a large degree of expenditure. The modeling of variants requires restarting of the process from the structural or behavior model level.
Large expenditure on maintenance. When changes are made the production process has to be restarted, in the worst case it has to be restarted at the structural model.
Unnecessary depth of the diagnostic knowledge. The diagnostic knowledge which is to be found in the simulation database is very deep or too extensive for use in a vehicle. The acquired diagnostic knowledge therefore has to be greatly simplified so that it can be used.

Even though both methods can be very satisfactorily applied for some cases, there are a large number of other cases in which the model-based method is too complex and other cases in which the manual production of the diagnostic knowledge is too risky. The system is typically too extensive to be processed manually but at the same time complex modeling is not worthwhile. In such situations simplified modeling would be desirable so that the process provides high quality diagnostic knowledge for an acceptable degree of expenditure.

It is also known that it is possible to use known path search algorithms to find connections and functional relationships in structural models and to identify the associated components correctly. At the University of Paderborn with the support of the DFG under project number KI529/7-1; Schw120/56-1 the reliability of various path search algorithms has been investigated. The results were published in the form of a technical report “Topological Analysis of Hydraulic Systems” at the University of Paderborn by Benno Stein und Andre Schulz in June 1997. Therefore, starting with the physical structural model, the system topology, which is converted into a graph corresponding to the graph theory mentioned above, for example from DE19742450A1, it is possible with path search algorithms to determine, for a predefined functional relationship, the associated path in the structural graph with the associated components automatically and correctly with computer support.

In view of the fact that the manual production of diagnostic knowledge is often insufficient and the classic, model-based procedure is often too complex, the invention aims at providing a solution which lies between the two.

On the basis of the prior art described above, the object according to the invention is therefore to specify an alternative form of computer-supported diagnostics which only requires reduced model formation, in particular without the modeling of a behavior model, and without simulation in order to generate decision-related diagnostic knowledge.

The solution is achieved with a computer-supported diagnostic system according to claim 1. Advantageous embodiments are contained in the dependent claims and the description of the invention.

The solution is achieved with a computer-supported diagnostic system in which the physical structure of the technical system to be diagnosed is implemented in the form of a structural model. If a fault code occurs in a component of the technical system which is capable of self-diagnostics, and thus also in the structural model, the fault location is searched for with a parameterizable path search by means of the path search algorithm as a function of the fault which has occurred in the structural model. The parameterization of the path search is carried out here by means of fault-specific heuristics. A heuristic in the sense of the invention is here a software module which can be selected as a function of a fault which has occurred, which module contains a fault-specific evaluation algorithm which contains information about the set of candidates which are to be included in the search for the fault, and which contains rule lists with fault record conditions which are used for a fault decision by the evaluation algorithm. The fault location is found-if a state variable of a component in the structural model meets a fault record condition.

In one embodiment, a path search algorithm is integrated here in the evaluation algorithm of the heuristic. Then, there can be a fault-specific path search algorithm for each fault.

In another advantageous embodiment of the invention, the heuristic serves merely for parameterizing the path search, also referred to as informed graph search below. This has the advantage that the same path search algorithm can be used each time for the path search irrespective of the fault. The parameterization of the fault which has respectively occurred is then carried out by means of the evaluation algorithm which cooperates with the path search algorithm in this case. The evaluation algorithm is then based on the system observables and system variables to be examined and determines when a fault record condition is met for a system variable or system observable.

The diagnostic system according to the invention is advantageously suitable for technical systems with a topology in which the components of the technical system which are capable of self-diagnostics communicate with one another via a databus and with a bus controller. In this case it is expedient to extend the microprocessor which performs the function of the bus controller in such a way that it is also capable of incorporating the diagnostic system according to the invention and carrying out the diagnostics on the basis of the structural model. The extension can mainly consist here of reserving sufficient working memory and sufficient program memory as well as of using a microcontroller which is suitably dimensioned in terms of its computing power. The computing power is not particularly critical here since only the bus communication has to take place in real time, as it were. The diagnostics do not need to be carried out in real time.

The main advantage which is achieved with the invention is the reduced expenditure on the formation of models. Resorting to the fault codes of the components of the technical system which are capable of self-diagnostics makes it possible, in combination with the fault-specific codes, to dispense with the modeling of a behavior model and to dispense with a complex simulation in which, in known model-based diagnostic systems, all the possible system states have to be run through and evaluated in order to be able to set up a database with diagnostic knowledge, and it is only with such knowledge that the actual diagnosis can then be carried out. Although consequently the diagnostic system according to the invention is restricted to those faults which can be detected by the components of the structural model which are capable of self-diagnostics, everyday experience reveals that this covers approximately 90% to 95% of the faults which occur, and the simplified troubleshooting with heuristics provides better results for troubleshooting than a model-based diagnostic system which calculates all the conceivable variants of the system states and does not even arrive at a uniquely defined result, so that the troubleshooting is still up to the person skilled in the art who of course adopts a heuristic approach in any case.

It is therefore possible to state that a further advantage of the diagnostic system according to the invention is that it is better adapted to the approach of a person skilled in the art and as a result the diagnostic results can be assessed better by this person skilled in the art.

The invention will be explained in more detail below using graphic illustrations, of which:

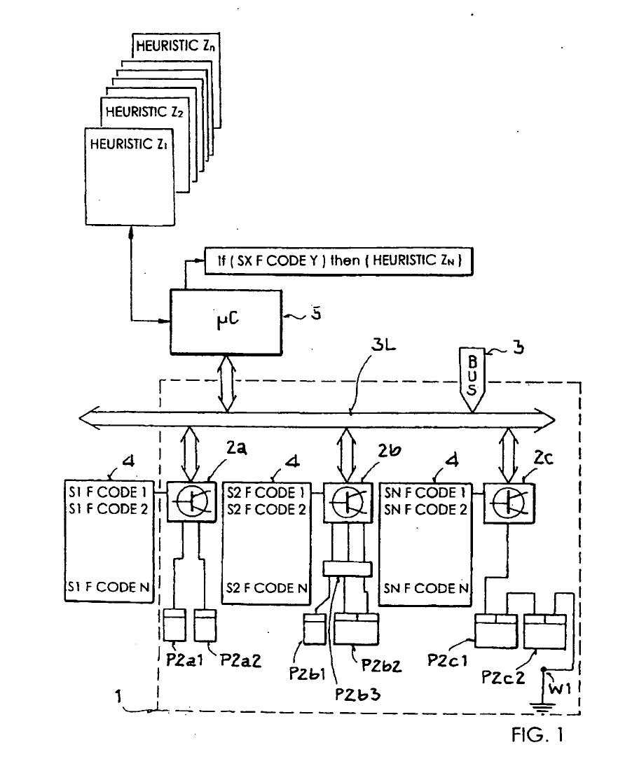

FIG. 1 is an overview graphic with the most important elements of the invention,

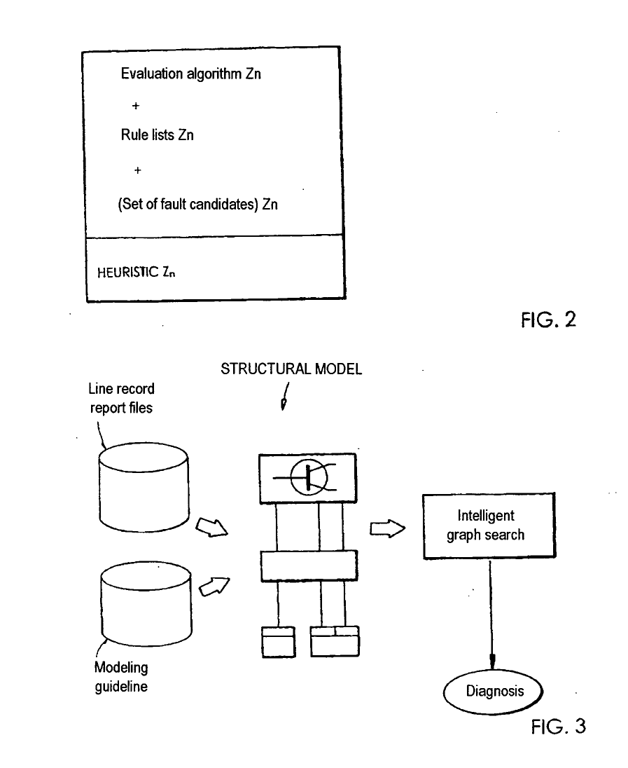

FIG. 2 is a block graphic illustrating a heuristic which is implemented using software,

FIG. 3 is a brief illustration of the invention explaining the main difference of the invention compared to a model-based diagnostic system from the prior art, and

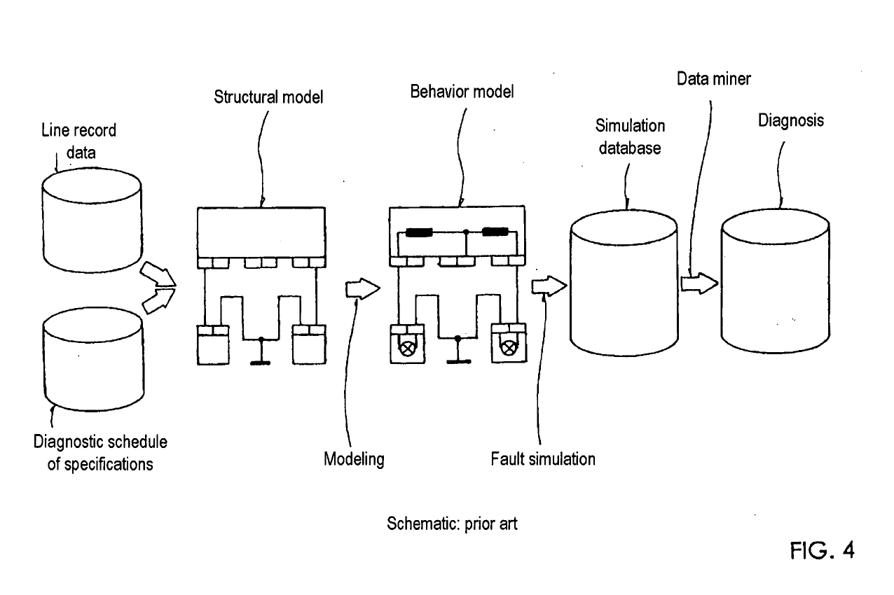

FIG. 4 is a model-based diagnostic system from the prior art.

The largest part of the expenditure in a model-based method from the prior art according to FIG. 4 is required by the behavior modeling and the subsequent simulation. Furthermore, the model depth arising from this complex process is not used in the reality of a workshop. If the modeling of the diagnostic system is restricted to the structural model, that is to say to the system topology, it is also possible to extract diagnostic knowledge from it. Compared to the previously known, model-based diagnostics, the diagnostic knowledge which is acquired is simplified but the resulting depth corresponds to that which can be used by contemporary system diagnostics in a workshop.

FIG. 3 illustrates the simplified modeling on the structural model level according to the invention.

Here, only the structural model of the technical system to be analyzed is used. The only information which is required apart from the topology is types of components which are present in the structural model; different procedures are adopted for the analysis of the structural model depending on whether the components are working elements, supply elements or switching elements. These different procedures are implemented with an informed graphic search.

The informed graphic search is a parameterized depth search starting in the control device which has signaled a fault code on the basis of its self-diagnostics. A fault code is composed here of information as to where the fault code originates from and as to which type of fault it is. In this context, the type of fault is the most important parameter for controlling the informed graphic search. The type of fault determines here how the periphery of the signaling control device which is being searched is to be handled.

The parameterization is composed of a heuristic Zn which is specific to the type of fault and which predefines the scope of the periphery to be examined which is to be transferred into the set of fault candidates Zn of the fault code Zn to be currently processed. An exemplary heuristic is illustrated in FIG. 2. The heuristic Zn not only includes the fault-specific evaluation algorithm Zn of the procedure with the components to be examined but also reflects the procedure according to the modeling guide line. The modeling guideline is a collection of prescriptions which have to be complied with when fault-specific rule lists Zn are produced. Examples of such rule lists: “ground nodes must not be relieved of load” or “in the short circuit to ground type of fault, switches are provided with the “clamped” fault mode”. The rule lists therefore indicate the assignment of the state variables of a component in the structural model in which the component is to be evaluated as faulty by the evaluation algorithm.

The most important types of fault which can be detected by the control devices are “line break”, “short circuit to ground” and “short circuit to supply”. These types of fault occur in reality both individually and in combination-with other types of fault, for example as a “line break and short circuit to ground”. In order to be able to cover such cases, the heuristics according to the invention must be able to be used in combination or be connected one behind the other.

“Line Break” Heuristic

In the “line break” type of fault, all the components on the route between the control device and the ground node are taken into account. A distinction is made here according to component types:
Plug: with the “line break” type of failure, plugs are suspected.
Line: with the “line break” type of failure, lines are suspected.
Components: with the “defect” type of failure, components are suspected; with the “line break” type of failure the ground node is suspected.

If a plurality of ground nodes are located in the periphery which is to be examined with the path search algorithm and the heuristic, all the ground paths are taken into account. This causes superfluous components to be adopted and must subsequently be assessed by the person skilled in the art. However, the person skilled in the art then has indications as to which components are to be examined in more detail in which ground paths. If other information items are present in the structural model, for example information as to which ground path is a standard one, the troubleshooting can be limited further to those ground paths which have been newly added as a result of a short circuit.

“Short Circuit to Ground” Heuristic

In the “short circuit to ground” type of fault, all the components on the path between the control device and the last component before the ground are taken into account. Here, component types are differentiated:
Plug: plugs are not suspected.
Line: with the “short circuit to ground” type of failure lines are suspected.
Component: components are differentiated more finely:
Switch: with the “clamped” type of failure switches are suspected.
Motors: with the “short circuit” type of failure motors are suspected (alternative: “defect”).
Other: with the “defect” type of failure other components are suspected.

“Short Circuit to Supply” Heuristic.

In the “short circuit to supply” type of fault, all the components on the path between the control device and the ground are taken into account. Here, component types are differentiated:
Plug: plugs are not suspected.
Line: with the “short circuit to supply” type of failure lines are suspected.
Components: components are differentiated more finely:
Switches: with the “clamped” type of failure switches are suspected.
Motors: with the “short circuit” type of failure motors are suspected (alternative: “defect”).
Other: with the “defect” type of failure other components are suspected.

In order to increase the quality of the acquired diagnostic knowledge, a number of extensions can be added. To do this, additional information is added to the structural model; this additional information can be utilized by the heuristics.

For the “short circuit to ground” heuristic, knowledge about existing ground paths is very useful since it permits the heuristic to abort the search in good time and makes manual subsequent improvement of the diagnostic knowledge superfluous.

The ground paths can be determined directly after the modeling of the topology by reference to the line set report files. Ground nodes must be able to be detected as such to do this; in the case of Mercedes-Benz it is possible to detect ground nodes by reference to the name since they have to start with the letter “W”. After the line set report files have been loaded and the topology has been modeled, the preprocessing can take place: the paths to all the neighbors are searched starting at each existing ground node and the components lying on them are marked as being part of the ground path. This search always ends on each path at the first component which has a nontrivial function (such components can be recognized from the name).After all, only plugs, junctions, lines, distributor nodes (they can also be recognized from the name) and the ground node itself lie on a ground path.

In many cases, components which belong to the periphery of a control device draw their ground from the control device itself. In such cases, these ground paths are not detected during the preprocessing. However, so that this still functions, the information can be transferred to the system via a ground line on the control device—virtual ground paths are inserted into the system topology in a certain way. In a “second” preprocessing step it is possible to adopt an analogous procedure to that for determining the ground paths during the preprocessing, and these paths are marked as ground paths.

Specification of Supply Paths

For the “short circuit to supply” heuristic, similar factors apply as for the “short circuit to ground” heuristic. The difference here is that the search does not have to take into account the supply paths themselves.

Further Types of Fault

There are further types of fault which up to this point have not been taken into consideration. These types of fault such as, for example, “signal implausible” or “CAN communication fault” are not electrical faults but rather logical faults. In the case of the “CAN communication fault” type of fault, only the CAN lines can be incorporated into the set of fault candidates. To do this, the CAN lines in the line set report files must have a suitable identification facility.

The graphic illustration in FIG. 1 gives a summary of the features of the diagnostic system according to the invention dealt with up to this point. The system topology of the technical system with the existing control devices 2a, 2b, 2c and the periphery P2a1, P2a2, P2b1, P2b2, P2b3, P2c1, P2c2 assigned to the control devices, and ground node W1 are registered and recorded in a computer-processable structural model 1. using data record report files. The structural model may be here, for example, a system graph composed of edges and nodes such as is known from graph theory and which has been converted into a junction tree by means of triangulation so that it can be processed with path search algorithms. The structural model also includes the communication structure of the control devices which are all networked via a databus 3 to data lines 3L which are typical of a databus. The term structural model is understood in the sense of the invention to be any form of representation of the system topology of the technical system. The individual forms of representation such as data record report files, graph or junction tree can be converted into one another by computer by applying corresponding conversion programs. Each of the control devices which is capable of self-diagnostics has a fault code list 4 which is agreed in the technical sense and which contains, for each control device, the list of fault states which can be detected by this control device. Each fault code contains here information about the control device from which the fault report originates and about the type of fault which has occurred. In the exemplary embodiment in FIG. 1 it will be assumed, for example, that the format for the fault code is SXFCODEY. Then, for example, SX specifies the control device from which the fault report originates and FCODEY specifies the type of fault which has occurred. Different control devices and different types of fault can be identified according to the assignment of the variables X and Y.

With a microcontroller 5 in which the diagnostic system is implemented by software with a structural model, diagnostic program, heuristics and path search algorithms, the bus messages on the databus are also read. Whenever a fault report is transmitted on the databus, the diagnostic system which is described here is applied. This means that with a diagnostic program which is capable of running, the path search algorithm or algorithms are supplemented with a fault-specific heuristic Zn in a first step by reference to the fault code which has occurred. The heuristic contains here the set of fault candidates which are to be examined, the rule lists for the presence of a fault setting condition and the fault-specific evaluation algorithm which specifies which state variables of the individual components are to be examined according to which criteria, and the rules according to which branching is to be carried out at nodes of the structural model with the path search algorithm. The fault location or the defective component are considered to be found according to the diagnostic system according to the invention if a fault record condition has been found for a component with the path search algorithm which is parameterized by the heuristic.

Prototype Implementation

The approach presented here for acquiring diagnostic knowledge has been implemented as a prototype and has the following features:

Modeling of the Topology
Determination of the ground paths
Three heuristics (“line break”, “short circuit to ground” and “short circuit to supply”), which can be executed individually or in combination.
Compliance with the current modeling guidelines, i.e. the correct types of component are determined from the periphery for each type of fault and assigned to a fault mode.

1. A diagnostic device having a microcontroller (5) which is connected to a databus (3) of a technical system via a data link (3L), characterized
in that a computer-processable structural model (1) of the technical system is implemented in the microcontroller (5),
in that an executable diagnostic program is implemented in the microcontroller (5),
in that a communications program in the microcontroller (5) also reads a fault message occurring on the databus,
and in that the diagnostic program carries out troubleshooting as a function of the fault message which occurs, by means of a graph search, which can be parameterized by a fault-specific heuristic, in the structural model.

2. The diagnostic device as claimed in claim 1, characterized in that the fault-specific heuristic is a software module which contains an evaluation algorithm, one or more rule lists and a set of the fault candidates to be examined.

3. The diagnostic device as claimed in claim 1, characterized in that a path search algorithm is integrated into the heuristic.

4. The diagnostic device as claimed in claim 1, characterized in that the heuristic cooperates with a path search algorithm.

5. A computer-supported diagnostic system in which the physical structure of the technical system to be diagnosed is implemented in the form of a structural model, characterized
in that when a fault message from a component of the technical system occurs, and thus also occurs in the structural model, the fault location within the structural model is searched for with a fault-specific path search which can be parameterized by a heuristic.

6. The computer-supported diagnostic system as claimed in claim 5, characterized in that the heuristic is a software module composed of an evaluation algorithm, at least one rule list and a set of the fault candidates to be examined.

7. The computer-supported diagnostic system as claimed in claim 5, characterized in that a path search algorithm is integrated into the heuristic.

8. The computer-supported diagnostic system as claimed in claim 5, characterized in that the heuristic cooperates with a path search algorithm.

9. A diagnostic method for technical systems, characterized
in that a structural model of the technical system is firstly generated from information relating to the system topology,
in that furthermore a fault-specific heuristic with an evaluation algorithm, at least one rule list and with a set of the fault candidates to be examined is produced for each fault code of those components of the technical system which are capable of self-diagnostics,
in that furthermore a path search which can be parameterized by the heuristic is carried out within the structural model in order to find the fault location.

10. The diagnostic method as claimed in claim 9, characterized in that the path search starts at the component which has reported a fault.

11. The diagnostic method as claimed in claim 9, characterized in that the path search is limited to the components which are contained in the set of fault candidates.

12. The diagnostic method as claimed in claim 9, characterized in that the heuristic permits short circuits to ground to be found.

13. The diagnostic method as claimed in claim 9, characterized in that the heuristic permits short circuits to the supply path to be found.

14. The diagnostic method as claimed in claim 9, characterized in that the heuristic permits line breaks in the system topology to be found.

15. The diagnostic method as claimed in claim 9, characterized in that the heuristic permits components which cause logic errors to be found.
